(19) United States
(12) Patent Application Publication
(10) Pub. No.: US 2015/0205341 A1
(43) Pub. Date: Jul. 23, 2015

(54) BUS ENERGY CONSUMPTION REDUCTION APPARATUS AND METHOD

(71) Applicant: Microsemi Corp. - Analog Mixed Signal Group, Ltd., Hod Hasharon (IL)

(72) Inventor: Tamir LANGER, Tel Aviv (IL)

(21) Appl. No.: 14/583,829

(22) Filed: Dec. 29, 2014

Related U.S. Application Data
(60) Provisional application No. 61/930,178, filed on Jan. 22, 2014.

(51) Int. Cl. G06F 1/32

(52) U.S. Cl. CPC G06F 1/324; G06F 1/3296

(57) ABSTRACT

An energy consumption reduction apparatus for a bus comprising: a control circuitry comprising a voltage detector in communication with a line of the bus, the voltage detector arranged to detect the voltage on the bus line; and a controllable current source arranged to provide a current to the bus line responsive to a current activation signal of the control circuitry, wherein, responsive to the detected voltage becoming greater than a predetermined low threshold, the control circuitry is arranged to output the current activation signal.

### TECHNICAL FIELD

The invention relates generally to the field of electronic busses, and in particular to a bus energy consumption reduction apparatus and method responsive to monitoring of bus transitions.

### BACKGROUND

Electronic busses are often used to transmit signals among a plurality of interconnected devices. In some busses any one of a plurality of devices may be configured to control one or more signal lines of the bus. Typically, in such a case, the devices are connected to such a signal line with open drain outputs, and thus are configured to actively drive the signal line low when desired, and allow the signal line to be pulled up when not actively driving the line low. I²C/SMB buses are common physical layer protocols that use open-drain outputs to pull down the data and clock signal lines, and pull-up resistors or current sources are provided to pull the signal line voltage back up when the respective bus signals are released. Each bus comprises a serial data (SDA) line and a serial clock (SCL) line. When either of the I²C/SMB lines are pulled low by a connected device, current flows through the provided pull-up resistor from the power supply to the respective connected device. Alternately, in certain embodiments, the device which has driven the SCL line low may activate a current source when releasing the signal line thus actively enabling pull up. The subject embodiments will be described below in particular in relation to an I²C or SMB bus embodiment, however this is not meant to be limiting in any way. The I²C bus specification is available from NXP Semiconductors N.V, Eindhoven, The Netherlands, the entire contents of which is incorporated herein by reference.

For the SDA line, in case of a multiple byte transmission, there is no limitation on how long the line may be held low. Therefore, current may be drawn from the pull-up power supply for a significant amount of time. For fast I²C modes, such as fast and fast-plus modes, the rise time limitation (120 ns for fast-plus mode) requires the use of a low resistance pull-up, yielding significant amount of power consumed from the bus supply via the pull-up resistor when the line of the bus is held low.

Signals on the SDA and SCL lines allow multiple devices to be connected on the same bus, as shown in FIG. 1 which illustrates a high level block diagram of an I²C bus 10, according to the prior art. I²C bus 10 comprises: a supply voltage VDD1; an SDA line; an SCL line; and a pair of pull-up resistors RP coupled between a respective one of the SDA line, the SCL line and supply voltage VDD1. A master device 20 and a plurality of slave devices 30 are each connected to lines SDA and SCL. A plurality of master devices 20 may also be supplied. Optionally, as shown, one or more of slave devices 30 may receive power from a separate power supply, respectively labelled VDD2 and VDD3. Both SDA and SCL lines are defined as bidirectional lines. When the bus is free, both lines are high responsive to the action of the respective pull-up resistors RP. The output stages of master device 20 and slave devices 30 must have an open-drain or open-collector to perform the necessary wired-AND function. Data on the I²C bus can be transferred at rates of up to 100 kbit/s in the standard-mode, up to 400 kbit/s in the fast-mode, up to 1 Mbit/s in fast-mode plus, or up to 3.4 Mbit/s in the high-speed mode. The bus capacitance limits the number of interfaces which may be connected to the bus.

Since lines SDA and SCL are connected in a wired-AND configuration, a low-level (digital “0”) signal on the I²C bus line is achieved by pulling the line low, and a high-level (digital “1”) is achieved by releasing the line, thereby letting the external pull-up resistors pull the signal voltage up towards the bus power supply voltage, creating an RC network, where R is the pull-up resistor RP and the C is the bus capacitance (not shown).

Due to this behavior, current is drawn from the power supply when either line SDA or SCL are pulled low by one of the devices 20, 30 on the bus. While the SCL signal is a clock signal, having a duty-cycle of about 50%, the SDA signal is a data signal, and may be pulled low by either master device 20 or any slave device 30 for an extended period, e.g. when the transmitted data is a series of digital “0”s.

Thus, a current will be drawn from power supply VDD1 via the respective resistor RP to the device driving the respective line low. The current drawn during the low level state of the SDA signal may be considerably large. For example, for Fast+mode (SCL speed of ≦1000 KHz), the maximum allowed rise time for both SDA and SCL signals is 120 ns. Assuming bus capacitance of 400 pF and supply voltage VDD1 of 3.3V, the external pull-up resistor RP required pulling the SDA line voltage to the VIH threshold defined by the I²C specification, i.e. 0.7V_{DD}, can be calculated from the following equation:

$${V}_{C} ( t ) = Vdd + ( {Vc}_{0} - Vdd ) \cdot {e}^{- \frac{t}{RC}} \qquad EQ . 1$$

where Vc(t) is the SDA line voltage, i.e. the capacitance voltage, Vdd is the I²C bus voltage, i.e. VDD1, Vc₀ is the initial voltage of the bus capacitance, R is the resistance value of pull-up resistor RP, C is the bus capacitance and t is the time required to reach Vc(t).

For: Vc(t)=VIH, i.e. 0.7 V_{DD}, and Vdd=3.3V; VCO=0.2V; and taking the maximum allowed bus capacitance of 550 pF for C, solving for R in EQ. 1 yields a resistance R≦257.5 ohms. Taking the closest standard-value 1% resistor yields a resistance R=255 ohms. In the above example, when one of the SDA and SCL lines is pulled low, the current drawn from power supply VDD1 while the respective signal is low will thus be:

3.3V/255Ω=12.9 mA EQ. 2

For the SDA line, the current of EQ. 2 may be drawn for a significant time interval if the data signal on the SDA line comprises a plurality of digital 0's. For a single byte transaction, if the data byte sent over the bus is “00”, the SDA line will be pulled low for 8+1 (ACK) SCL clocks. The ACK signal is an acknowledgement signal sent by the receiving side, and is indicated by a low level (“0”) if the receiving side has acknowledged the data, and high level (“1”) if not.

Therefore, if multiple bytes are sent over the bus, the SDA line may be held low continuously for the entire transmission. For a 16 byte transmission, i.e. 128 bits of information, each byte is followed by an ACK bit. Therefore, the maximum number of consecutive “0”s that may be sent in this case is (8+1)×16=144. Assuming an SCL speed of just above 400 KHz (above this frequency either fast plus or high speed modes must be used), for example 500 KHz, the time interval for sending 72 consecutive bits of 0s is 144×(1/500000)=288 μs. This scenario (and even longer intervals) might be the case, for example, for reading the content of an uninitialized Electrically Erasable Programmable Read-Only Memory (EEPROM) with an I²C interface. The data read from the EEPROM may result in a series of 0's for the whole memory space being read. During the entire reading time, the current drawn from the bus will be proportional to the pull-up resistor value.

### SUMMARY OF THE INVENTION

Accordingly, it is a principal object of the present invention to overcome the disadvantages of prior art buses. This is provided in one embodiment by an energy consumption reduction apparatus for a bus comprising: a control circuitry comprising a voltage detector in communication with at least one signal line of the bus, the voltage detector arranged to detect a rise in the voltage of the signal line; and a controllable current source arranged to provide a current to the signal line, responsive to a current activation signal of the control circuitry, wherein, responsive to the detected voltage becoming greater than a predetermined low threshold, the control circuitry is arranged to output the current activation signal.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level schematic diagram of an I²C bus arrangement according to the prior art;

FIG. 2 illustrates a high level schematic diagram of an SDA portion of an I²C bus, comprising a bus energy consumption reduction apparatus according to certain embodiments;

FIG. 3 illustrates graphs of the various signal of the SDA bus portion of FIG. 2;

FIG. 4 illustrates a high level schematic diagram of a control circuitry of the bus energy consumption apparatus of FIG. 2;

FIG. 5 illustrates a high level schematic diagram of an SCL portion of an I²C bus, comprising the bus energy consumption apparatus of FIG. 2; and

FIG. 6 illustrates a high level flow chart of a method of reducing energy consumption in a bus, according to certain embodiments.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

FIG. 2 illustrates a high level schematic diagram of an SDA portion 100 of an I²C bus, comprising a bus energy consumption reduction apparatus 110, according to certain embodiments. Bus portion 100 comprises: the serial data line of the bus, denoted SDA; bus energy consumption reduction apparatus 110, comprising a control circuitry 120 and a controllable current source 130; a supply voltage VDD; a pull-up impedance element 140; a bus capacitance, denoted CBUS; a master device 20 comprising a transistor, denoted MT; and a slave device 30 comprising a transistor, denoted ST.

In one embodiment, data line pull-up impedance element 140 comprises a resistor. In another embodiment, bus capacitance CBUS comprises the capacitance of all elements of the bus. Bus portion 100 is illustrated as having coupled thereto a single master device 20 and a single slave device 30, however this is not meant to be limiting in any way and any number of master devices 20 and slave devices 30 may be coupled to bus portion 100 without exceeding the scope. Each of master device 20 and slave device 30 are illustrated as comprising an n-channel metal-oxide-semiconductor field-effect transistor (NMOSFET), however this is not meant to be limiting in any way and devices incorporating any type of transistor known in the art of buses can be utilized without exceeding the scope. In one embodiment, pull-up impedance element 140 exhibits a resistance on the order of 3 kΩ and controllable current source 130 is arranged to output a current on the order of 33 mA.

For ease of understanding, bus energy consumption apparatus 110 is described as an arrangement to reduce the energy consumption of line SDA of bus 100, however this is not meant to be limiting in any way. In another embodiment, as will be described further below, bus energy consumption apparatus 110 is arranged to reduce the energy consumption of line SCL of the bus, without exceeding the scope. Similarly, bus energy consumption apparatus 110 may be utilized with other busses without exceeding the scope.

A power input of controllable current source 130 is coupled to supply voltage VDD and a control input of controllable current source 130 is coupled to an output of control circuitry 120. The output of controllable current source is coupled to line SDA. An input of control circuitry 120 is coupled to line SDA. Pull-up impedance element 140 is coupled between supply voltage VDD and line SDA. Bus capacitance CBUS is coupled between line SDA and a common potential. The drain of each of transistor MT and transistor ST is coupled to line SDA and the source of each thereof is coupled to the common potential.

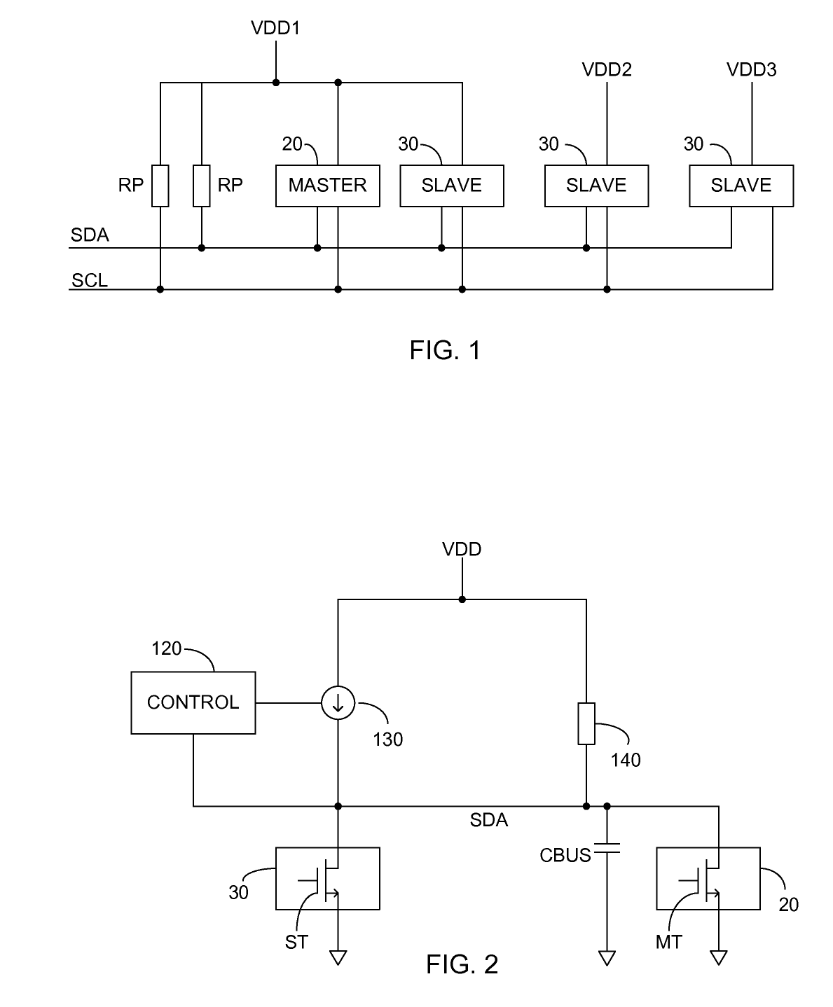

In operation, control circuitry 120 is arranged to monitor the voltage on line SDA. When line SDA is held low by the closing of either transistor MT or ST, current flows through pull-up impedance element 140 to the closed transistor. In an embodiment where pull-up impedance element 140 exhibits a resistance of 3 kΩ and supply voltage VDD is 3.3V, the current flowing through pull-up impedance element 140 is about 1.1 mA, as opposed to the 12.9 mA current of the bus of the prior art of FIG. 1, as described in EQ. 2.

If both transistors MT and ST are open, i.e. a logical “1” is being transmitted over line SDA, the current flowing through pull-up impedance element 140 begins to charge bus capacitance CBUS and the voltage detected by control circuitry 120 on line SDA begins to rise. In the event that the detected voltage exceeds a predetermined value, control circuitry 120 is arranged to output a current activation signal to controllable current source 130. Responsive to the current activation signal, controllable current source 130 is arranged to output a current to further charge bus capacitance CBUS. Controllable current source 130 is arranged to rapidly charge bus capacitance CBUS such that the SDA voltage rises towards supply voltage VDD within a predetermined time frame. In particular, as described above in relation to FIG. 1, in one embodiment controllable current source 130 is arranged to charge bus capacitance CBUS such that the SDA line voltage rises to voltage threshold VIH, i.e. 70% of supply voltage VDD, within a time frame of 120 ns. Voltage threshold VIH is defined by the relevant specification.

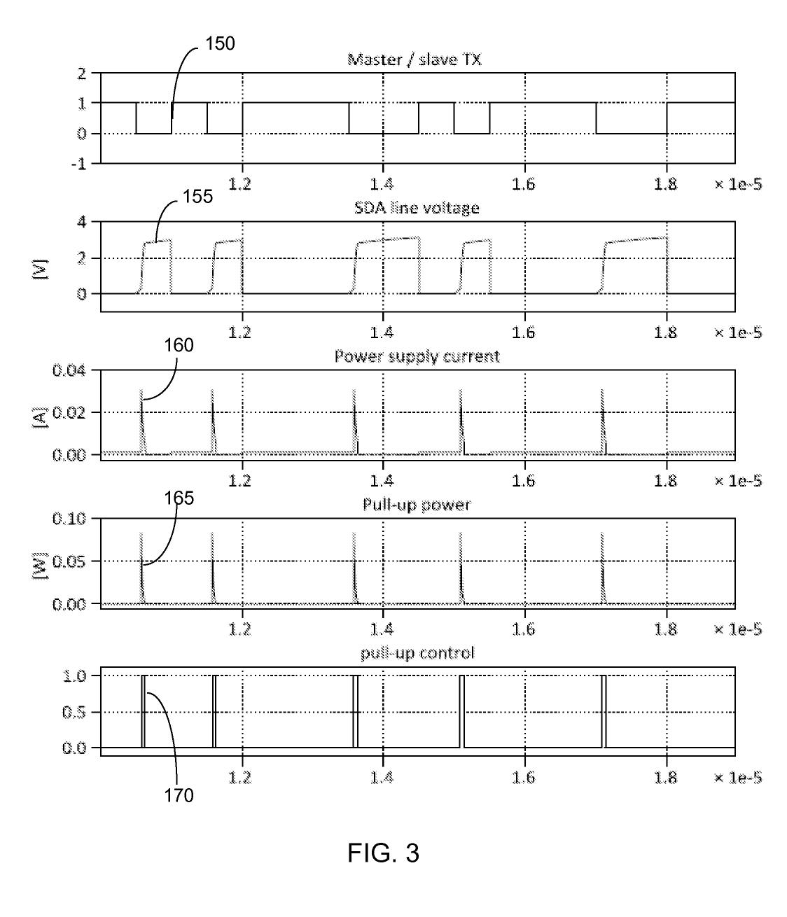

In one embodiment, when the voltage of line SDA exceeds voltage threshold VIH control circuitry 120 is arranged to output a current deactivation signal to controllable current source 130. Responsive to the output current deactivation signal, controllable current source 130 is arranged cease the output of the current. Thereafter, pull-up impedance element 140 remains coupled to line SDA so that line SDA doesn't float. Furthermore, bus capacitance CBUS may be charged towards VDD from VIH via current flowing through pull-up impedance element 140. In another embodiment, control circuitry 120 is arranged to output the current deactivation signal after a predetermined time period has elapsed from the output of the current activation signal. In one further embodiment, the predetermined time period is the maximum rise time of the I²C specification. In one embodiment, as will be described below in relation to FIG. 3, current activation signal and current deactivation signal are opposing states of a single signal.

FIG. 3 illustrates graphs of the various signals of SDA bus portion 100, the x-axes of all of the graphs representing a common time axis. Graph 150 illustrates a signal representing the control input to one of transistors MT and ST, the y-axis representing a logical “0” or “1”. Responsive to a low level at the control input, transistor MT or ST is open, and in the event that both transistor MT and ST are open, line SDA is at a logical “1”. If either transistor MT or ST are closed, responsive to a high level signal at the respective control input, line SDA is at a logical “0.

Graph 155 illustrates the signal voltage on line SDA, the y-axis representing voltage. As can be seen, responsive to a low level at the control input of both transistors MT and ST, line SDA rapidly rises to a high voltage level, i.e. at least to voltage VIH. Once voltage VIH is achieved, line SDA continues to rise at a slower rate. Graph 160 illustrates the current flowing through line SDA from controllable current source 130 and data line pull-up impedance element 140, the y-axis representing current in Amperes. Graph 165 illustrates the power of the current of graph 160, the y-axis representing power in Watts. Graph 170 illustrates the output of control circuitry 120, the y-axis representing a logical “0” or “1”. When control circuitry 120 outputs a current activation signal, the signal is a logical “1”. When control circuitry 120 outputs a current deactivation signal, the signal is a logical “0”. As shown in the graphs of FIG. 3, the pull-up current arranged to charge bus capacitance CBUS is provided for only a short time, particularly as seen in graph 160, thereby significantly reducing the energy consumption of the bus, as can be seen in graph 165.

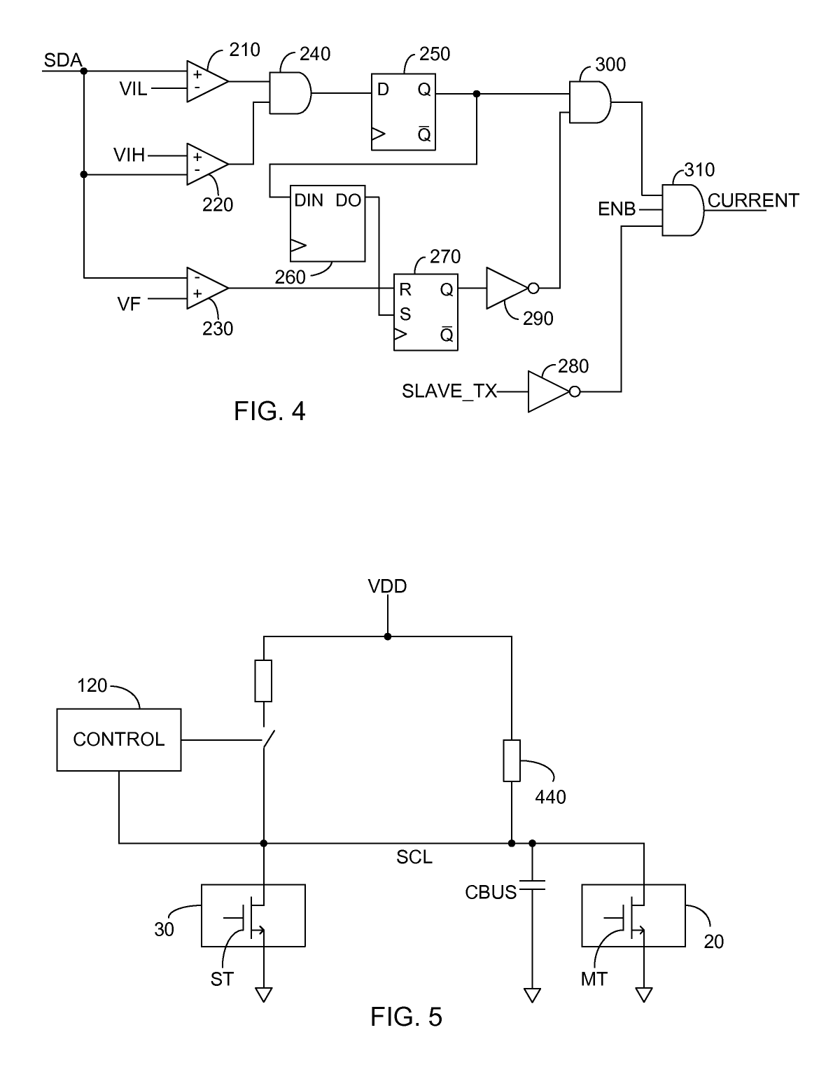

FIG. 4 illustrates a high level schematic diagram of a combinatorial logic embodiment of control circuitry 120 of bus energy consumption reduction apparatus 110 of FIG. 2. It is to be understood that other embodiments, including the use of a state machine controller, may be utilized, without exceeding the scope. Control circuitry 120 comprises: a low threshold comparator 210; a high threshold comparator 220; a fall value comparator 230; an AND gate 240; a D flip flop 250; a high threshold crossing detector 260, comprising a falling edge detection latch; a memory 270, comprising an SR latch; a pair of inverters 280, 290; an AND gate 300; and an AND gate 310. High threshold crossing detector 260 and memory 270 are illustrated as comprising clock driven flip flops, however this is not meant to be limiting in any way. In another embodiment, high threshold crossing detector 260 and memory 270, as well as D flip flop 250, can instead be implemented without a synchronous clock, for example being implemented with only logic gates.

A non-inverting input of low threshold comparator 210 is coupled to line SDA and an inverting input of low threshold comparator 210 is coupled to a predetermined low threshold, denoted VIL. An inverting input of high threshold comparator 220 is coupled to line SDA and a non-inverting input of high threshold comparator 220 is coupled to a predetermined high threshold, denoted VIH. The output of each of low threshold comparator 210 and high threshold comparator 220 is coupled to a respective input of AND gate 240. The output of AND gate 240 is coupled to the data input of D flip flop 250 and the non-inverting output of D flip flop 240 is coupled to a first input of AND gate 300 and to the data input of falling edge detection latch 260. The output of falling edge detection latch 260 is coupled to the set input of SR latch 270.

An inverting input of fall value comparator 230 is coupled to line SDA and a non-inverting input of fall value comparator 230 is coupled to a predetermined fall potential, denoted VF. The output of fall value comparator 230 is coupled to the reset input of SR latch 270 and the non-inverting output of SR latch 270 is coupled to a second input of AND gate 300, via inverter 290. A first input of AND gate 310 is coupled to the output of AND gate 300 and a second input of AND gate 310 is coupled to an enabling signal, denoted ENB. An optional third input of AND gate 310 is coupled, via inverter 280, to a slave device transmit signal, denoted SLAVE_TX, the path shown as a dotted line to emphasize its optionality. The output of AND gate 310 comprises the output of control circuitry 120 and is denoted ACTIVATE, where a logical “1” of AND gate 310 constitutes the current activation signal and a logical “0” of AND gate 310 constitutes the current deactivation signal. The clock inputs of each of D flip flop 250, falling edge detection latch 260 and SR latch 270 are connected to a common clocking signal, CLK.

Predetermined low threshold VIL is greater than predetermined fall potential VF and predetermined high threshold VIH is greater than predetermined low threshold VIL. In one embodiment, predetermined high threshold VIH is determined by the pull-up voltage specifications of the I²C/SMB bus, optionally being 70% of supply voltage VDD. In one embodiment, where supply voltage VDD exhibits a value of 3.3V, predetermined high threshold VIH exhibits a value of 2.31V, predetermined low threshold VIL exhibits a value of 0.2V and predetermined fall potential VF exhibits a value of 0.15V. In one embodiment, the frequency of the clock of D flip flop 250, falling edge detection latch 260 and SR flip flop 270 is 8 times greater than the frequency of the serial clock of the bus.

Falling edge detection latch 260 is arranged to be high for a single clock pulse of signal CLK when the input, i.e. the output of D flip flop 250, falls from high to low, thus setting SR latch 270. In on embodiment, SR latch 270 is implemented using a D flip-flop and combinatorial logic. In this embodiment, as long as the R input is set to HIGH, the output of the SR latch 270 is low. In order for the output of SR latch 270 to become HIGH, the R input must be LOW, and the S input must be HIGH. If both inputs are LOW, the output of SR latch 270 retains its previous value.

In operation, when the line SDA voltage is greater than above predetermined low threshold VIL and less than predetermined high threshold VIH, the outputs of both of comparators 210 and 220 are high. Therefore, the output of AND gate 240 is high and as a result the output of D flip flop 250 is set to high. The voltage of line SDA is greater than predetermined fall potential VF, thus the output of comparator 230 is also low, causing SR latch 270 to reset and its output to be set to low, thus providing a high signal to the second input of AND gate 300 via inverter 290, thereby the output of AND gate 300 is high. In the event that enabling signal ENB is high and optional slave device transmit signal SLAVE_TX is low, control circuitry 120 outputs the current activation signal CAS.

Optional enabling signal ENB, when low, is a signal generated by control circuitry 120 which allows deactivation of controllable current source 130 for any reason. Optionally, enabling signal ENB is generated by an external user input. Further optionally, enabling signal ENB is not provided.

In one embodiment, bus energy consumption reduction apparatus 110 is supplied within a slave device 30 coupled to the bus. In such an embodiment, in the event that transistor ST of the slave device 30 incorporating bus energy consumption reduction apparatus 110 is closed, i.e. the slave device 30 is pulling the bus low, slave device transmit signal SLAVE_TX is high thereby disabling controllable current source 130 without having to detect the voltage on line SDA.

When the voltage on line SDA rises above predetermined high threshold potential VIH, the output of comparator 220 becomes low, thereby the output of AND gate 240, D flip flop 250, AND gate 300 and AND gate 310 become low. Thus, responsive to the voltage on line SDA exceeding predetermined high threshold potential VIH, control circuitry 120 is arranged to deactivate signal CAS this disabling controllable current source 130. Controllable current source 130 is deactivated since bus capacitance CBUS is charged to the necessary pull-up voltage.

Additionally, responsive to the output of D flip flop 250 becoming low, falling edge detection latch 260 becomes high for a clock cycle, thus setting SR latch 270, causing the output of SR latch 270 to become high, and thus causing the AND gate 300 to become low. Thereafter, the output of D flip-flop 250 does not impact SR latch 270 since falling edge detection latch 260 only outputs a high pulse when the output of D flip flop 250 changes from high to low. The set input of SR latch 270 is now low, as is the reset input thereof, thereby the output of SR latch 270 will remain high until reset by comparator 230, as described below. When line SDA is pulled low by any master device 20 or slave device 30, bus capacitance CBUS discharges and the SDA voltage begins to fall. As the SDA voltage falls below predetermined high threshold potential VIH, but still above predetermined low threshold potential VIL, the output of comparator 220 becomes high, and the output of comparator 210 is high, and therefore the output of AND gate 240 subsequently the output of D flip flop 250 both become high. However, SR flip flop 270 will remain set, as described above, thus preventing activation of signal CAS by virtue of inverter 290 and AND gate 300. Advantageously, controlled current source 130 is not unnecessarily activated as it is not needed when the bus is being pulled low. When the SDA voltage falls below predetermined fall potential VF, the output of comparator 230 becomes high and SR latch 270 is reset, thus setting the output of SR latch 270 to low, thereby allowing the output of AND gate 300 to become high when the SDA voltage again rises above predetermined low threshold potential VIL, as described above.

FIG. 5 illustrates a high level schematic diagram of an SCL portion 400 of a bus, comprising a bus energy consumption reduction apparatus 410, according to certain embodiments. Bus portion 400 comprises: the SCL line of the bus; bus energy consumption reduction apparatus 410, comprising a control circuitry 120, a rise time pull-up impedance element 420 and an electronically controlled switch 430; a supply voltage VDD; a pull-up impedance element 440; a bus capacitance, denoted CBUS; a master device 20 comprising a transistor, denoted MT; and a slave device 30 comprising a transistor, denoted ST. In one embodiment, pull-up impedance element 440 comprises a resistor.

For ease of understanding, bus energy consumption apparatus 410 is described as an arrangement to reduce the energy consumption of the SCL line of the bus, however this is not meant to be limiting in any way and in another embodiment bus energy consumption apparatus 410 is arranged to reduce the energy consumption of the SDA line of the bus, without exceeding the scope.

A first end of rise time pull-up impedance element 420 is coupled to supply voltage VDD and a second end of rise time pull-up impedance element 420 is coupled to serial clock line SCL via electronically controlled switch 430. A control input of electronically controlled switch 430 is coupled to an output of control circuitry 120. An input of control circuitry 120 is coupled to serial clock SCL. Pull-up impedance element 440 is coupled between supply voltage VDD and serial clock SCL. Bus capacitance CBUS is coupled between line SCL and a common potential. The drain of each of transistor MT and transistor ST is coupled to line SCL and the source of each thereof is coupled to the common potential. The operation of bus energy consumption reduction apparatus 410 is in all respects similar to the operation of bus energy consumption reduction apparatus 110 of FIG. 2, with the exception that the current activation signal of control circuitry 120 is arranged to close electronically controlled switch 430 and the current deactivation signal of control circuitry 120 is arranged to open electronically controlled switch 430. Thus, instead of a controlled current source, rise time pull-up impedance element 420 is placed in parallel with pull-up impedance element 440 responsive to activation of signal CAS, and is removed from being in parallel with pull-up impedance element 440 responsive to deactivation of signal CAS.

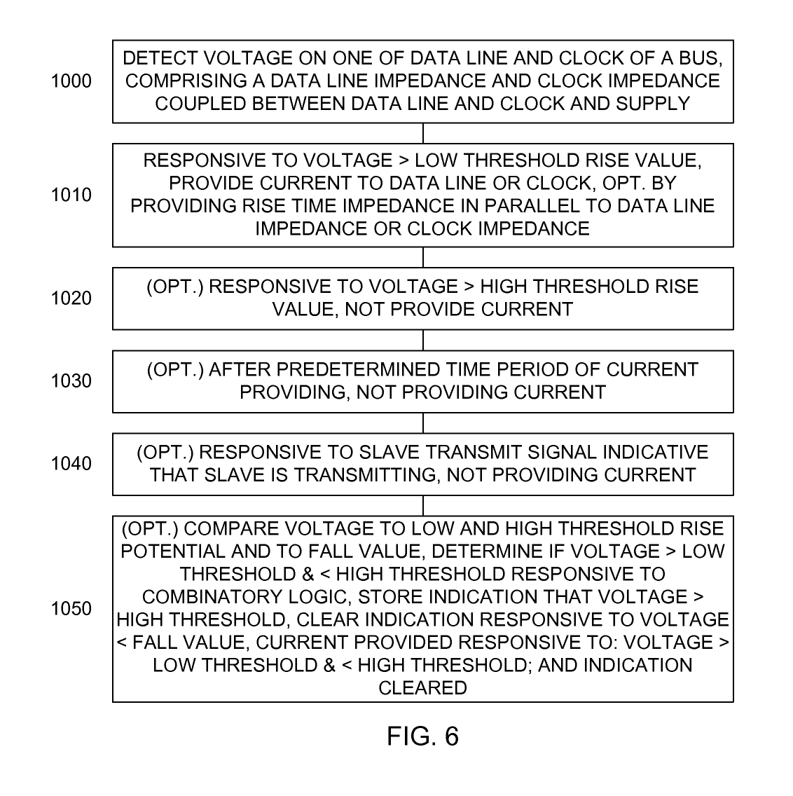

FIG. 6 illustrates a high level flow chart of a method of energy consumption reduction on a bus, according to certain embodiments. In stage 1000, the voltage a bus line is detected. Optionally, the bus line is one of an data bus line and a clock bus line. In stage 1010, in the event that the detected voltage of stage 1000 is greater than a low threshold, a current is provided to the bus line of stage 1000. Optionally, the current is provided by providing a rise time impedance in parallel to a line pull-up impedance.

In optional stage 1020, in the event that the detected voltage of stage 1000 is greater than a predetermined high threshold, the current of stage 1010 is not provided. The predetermined high threshold is greater than the predetermined low threshold of stage 1010. In one embodiment, the predetermined low threshold of stage 1010 is about 0.2V and the predetermined high threshold is 70% of the supply voltage of stage 1000.

In optional stage 1030, the current ceases to be provided after a predetermined time period within the current was provided. In one embodiment, the predetermined time period is the maximum rise time period determined by the bus specifications. In optional stage 1040, responsive to a slave transmit signal indicative that a slave device is transmitting a logical “0” on the bus, the current is not provided.

In optional stage 1050, the voltage of stage 1000 is compared to: a low threshold; a high threshold; and a fall potential, with high threshold>a low threshold>fall potential. In the event that the bus voltage of stage 1000 rises above the high threshold, disable the current provision of stage 1010 when the current is next between the low threshold and the high threshold, since the state is indicative that the bus is being pulled down. The fall potential is less than the low threshold, which is less than the high threshold. In the event that the voltage of stage 1000 is greater than the high threshold, an indication thereof is stored on a memory, the stored indication cleared from the memory when the voltage of stage 1000 becomes less than the fall potential. The current of stage 1010 is then provided responsive to: the voltage of stage 1000 being between the low threshold and the high threshold; and the stored indication being cleared.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. An energy consumption reduction apparatus for a bus comprising:
a control circuitry comprising a voltage detector in communication with a line of the bus, said voltage detector arranged to detect the voltage on the bus line; and
a controllable current source arranged to provide a current to the bus line responsive to a current activation signal of said control circuitry,
wherein, responsive to said detected voltage becoming greater than a predetermined low threshold, said control circuitry is arranged to output said current activation signal.

2. The apparatus of claim 1, wherein said controllable current source is arranged to not provide said current, responsive to a current deactivation signal of said control circuitry, and
wherein responsive to said detected voltage becoming greater than a predetermined high threshold, said control circuitry is arranged to output said current deactivation signal, said predetermined high threshold greater than said predetermined low threshold.

3. The apparatus of claim 2, wherein responsive to a falling state of said detected voltage, said control circuitry is arranged to output said current deactivation signal.

4. The apparatus of claim 3, wherein said voltage detector comprises:
a low threshold comparator, a first input of said low threshold comparator coupled to the bus line, and a second input of said low threshold comparator coupled to a voltage representation of the low threshold;
a high threshold comparator, a first input of said high threshold comparator coupled to the bus line, and a second input of said high threshold comparator coupled to a voltage representation of the high threshold;
a fall value comparator, a first input of said fall value comparator coupled to the bus line, and a second input of said fall value comparator coupled to a voltage representation of a fall value, said fall value less than said low threshold; and
a logic circuitry responsive to said low threshold comparator, said high threshold comparator and said fall value comparator and arranged to:
output said current activation signal responsive to detection of the bus voltage between said low threshold and said high threshold immediately subsequent to the bus voltage being less than said fall value; and
not output said current activation signal responsive to detection of the bus voltage between said low threshold and said high threshold immediately subsequent to the bus voltage being greater than said high threshold.

5. The apparatus of claim 1, wherein said controllable current source is arranged to not provide said current, responsive to a current deactivation signal of said control circuitry, and
wherein responsive to a falling state of said detected voltage, said control circuitry is arranged to output said current deactivation signal.

6. The apparatus of claim 1, wherein said controllable current source is arranged to not provide current, responsive to a current deactivation signal of said control circuitry, and
wherein said control circuitry is arranged to output said current deactivation signal after a predetermined time period has elapsed from said output of said current activation signal.

7. The apparatus of claim 1, wherein said control circuitry further comprises a slave transmit signal receiver in communication with a slave device coupled to the serial data line and serial clock line, said slave transmit signal receiver arranged to receive a slave transmit signal indicative that the slave device is transmitting,
wherein said controllable current source is arranged to not provide said current, responsive to a current deactivation signal of said control circuitry, and
wherein responsive to said received slave transmit signal, said control circuitry is arranged to output said current deactivation signal.

8. The apparatus of claim 1, wherein said controllable current source comprises a rise time pull-up impedance element arranged to couple a rise time impedance between the voltage supply potential and the one bus line, said current being a function of said rise time impedance and the supply voltage potential.

9. The apparatus of claim 8, wherein said rise time pull-up impedance element comprises a resistor, said resistor arranged to be switchably coupled in between the voltage supply potential and the one of the serial data line and the serial clock line.

10. An energy consumption reduction method for a bus line comprising:
detecting the voltage of bus line;
comparing the detected voltage to a predetermined low threshold; and
in the event that said detected voltage is greater than the predetermined low threshold, providing a pull-up current to the bus line; and
in the event that said detected voltage is not greater than the predetermined low threshold, not providing said pull-up current to the bus line.

11. The method of claim 10, further comprising:
comparing the detected voltage to a predetermined high threshold, said predetermined high threshold greater than said predetermined low threshold;
in the event that said detected voltage is greater than the predetermined high threshold, not providing said pull-up current.

12. The method of claim 11, further comprising:
detecting a falling state of the bus voltage responsive to determining that the bus voltage has fallen from being greater than the predetermined high threshold; and
responsive to the detected falling state, not providing said pull-up current when said detected voltage is greater than the predetermined low threshold and less than the predetermined high threshold.

13. The method of claim 12, wherein said detection of the falling state is responsive to a stored memory datum indicative that said detected voltage was greater than the predetermined high threshold, the method further comprising:
comparing the bus line to a fall value potential, said fall value potential exhibiting a value less than said predetermined low threshold;
in the event that said detected voltage is less than said fall value potential, clearing said memory datum.

14. The method of claim 10, further comprising, responsive to a falling state of said detected voltage, not providing said current.

15. The method of claim 10, further comprising, after a predetermined time period has elapsed from said providing said current to the one of the serial data line and the serial clock line, not providing said current.

16. The method of claim 10, further comprising:
receiving a transmit signal indicative that a device is transmitting on the bus line; and
responsive to said receiving of the transmit signal, not providing said current.

17. The method of claim 10, wherein said providing said current comprises switchably coupling a rise time impedance between the bus line and a voltage potential.
